(19) United States
(12) Patent Application Publication
(10) Pub. No.: US 2016/0092087 A1
(43) Pub. Date: Mar. 31, 2016

(54) MULTI-STATE SLIDER FEATURE FOR TRANSITIONING THROUGH AN E-BOOK

(71) Applicant: Kobo Inc., Toronto (CA)

(72) Inventor: Dae Hyuk Yoon, Toronto (CA)

(21) Appl. No.: 14/502,256

(22) Filed: Sep. 30, 2014

(51) Int. Cl. G06F 3/0484; G06F 3/041; G06F 3/0488

(52) U.S. Cl. CPC G06F 3/04847; G06F 3/04845; G06F 3/0488; G06F 3/041

(57) ABSTRACT

Examples described herein provide for a multi-state slider feature for enabling page and/or chapter transitions through an e-book.

### TECHNICAL FIELD

Examples described herein relate to a mufti-state slider feature for transitioning through an e-book.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (eBooks), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

E-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system that utilizes an e-reading device on which a multistate slider feature is implemented for transitioning through an e-book, according to an embodiment.

FIG. 2 illustrates an example of an e-reading device, for use with one or more embodiments described herein.

FIG. 3 illustrates an e-reading system in accordance with one or more embodiments.

FIG. 4 illustrates a method for implementing a multistate slider feature for transitioning through an e-book, according to an embodiment.

FIG. 5A and FIG. 5B illustrate an example of a multistate slider feature, according to one or more embodiments.

### DETAILED DESCRIPTION

Examples described herein provide for a multi-state slider feature for enabling page and/or chapter transitions through an e-book. According to some embodiments, a slider feature can be operated through a continuous interaction (e.g., continuous touch) to implement multiple transition types, as well as a state change from a first transition type to a second transition type to affect a type of transition that takes place.

In an example, a user can make contact with a computing device to move a slider feature, so as to affect a first type of e-book transition (e.g., by chapter transition). While the user maintains continuous contact with the slider feature, user input can signify a state change for the slider, followed by additional movement of the slider feature which is interpreted as an alternative type of e-book transition (e.g., by page type).

Examples described herein provide for a computing device that renders at least a portion of an e-book which is structured to include chapter designations. The computing device implements a slider feature to have multiple possible states, including at least (i) a first state, in which the slider feature can be moved linearly to signal transition through the e-book by chapter designation, and (ii) a second state, in which the slider feature can be moved linearly to signal transition through a current chapter by pages. The e-reading device can select to operate the slider feature in at least one of the first state or second state based on one or more designated user actions. When the slider feature is implemented in the first state, the e-reading device responds to input for moving the slider feature by transitioning through the e-book by chapter designations, to coincide with movement of the slider feature in the first state. When the slider feature is implemented in the second state, the e-reading device responds to input for moving the slider by transitioning through pages of a current chapter designation to coincide with movement of the slider feature in the second state.

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a mufti-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

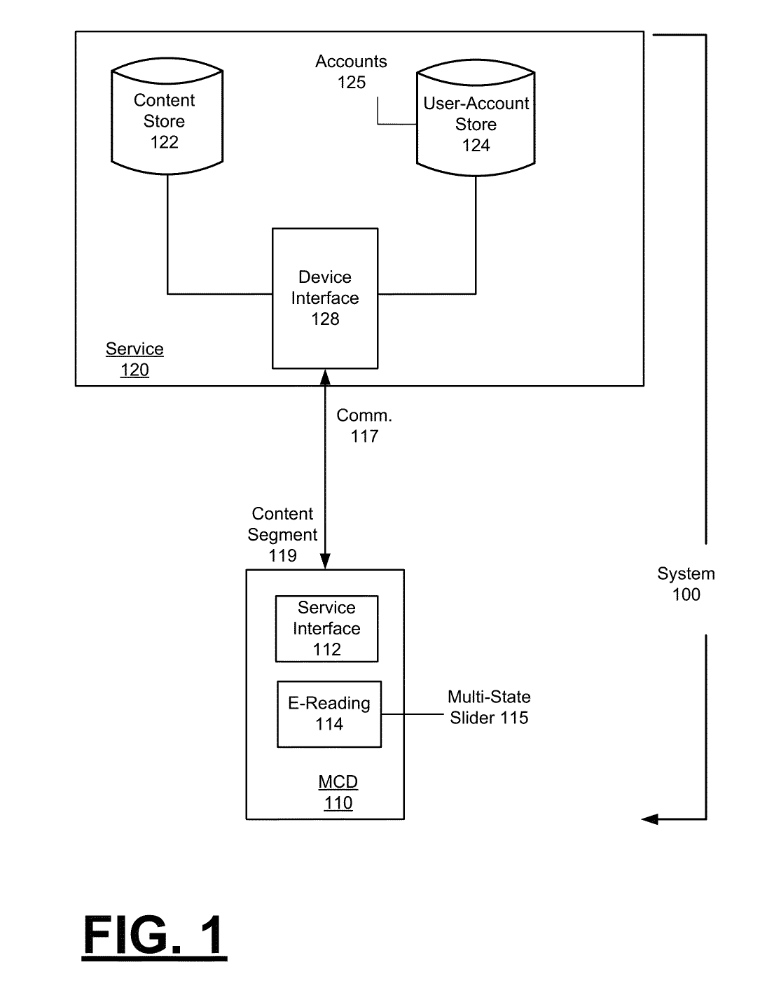

FIG. 1 illustrates a system that utilizes an e-reading device on which a multistate slider feature is implemented for transitioning through an e-book, according to an embodiment. In an example of FIG. 1, system 100 includes an e-reading device 110 and a network service 120. The network service 120 may include multiple servers and other computing resources that provide various services in connection with one or more applications that are installed on the e-reading device 110. By way of example, in one implementation, the network service 120 can provide e-book services which communicate with corresponding e-reading functionality provided on the e-reading device 110. The e-book services can enable e-books (including electronic magazines and other periodicals) to be downloaded or archived from e-reading device 110. The network service 120 can also provide other forms of content for download or streaming, such as videos or music. In this way, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can correspond to a mobile computing device (e.g., tablet) that runs an e-reading application to link the device to the network service 120 in order to enable e-books provided through the service to be viewed and consumed. Still further, by way of example, the e-reading device 110 can be equipped with hardware and software to optimize certain application activities, such as rendering of electronic content (e.g., e-books, including electronic magazines and other periodicals). For example, the e-reading device 110 can have a tablet like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., content item such as an e-books), which can be stored in the resource store 122. As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

The e-reading device 110 can include a service interface 112 and an e-reading component 114. The e-reading device 110 can execute the service interface 112 to receive resources and data from the network service 120. The service interface 112 can signal, to the network service 120, an identifier for the user and/or user account. The service interface 112 can interface with the network service 120 to receive resources such as applications and content items (e.g., e-books, music files, etc.) from the network service. Optionally, the e-reading device 110 can communicate with multiple services in order to receive resources. The resources that can be received can be responsive to user-input or action (e.g., purchasing input), or automated (e.g., automatic download of new issue of periodical based on user subscription data).

The e-reading device 110 can execute the e-reading component 114 to enable e-reading activities. In one aspect, the e-reading component 114 can render paginated content from e-books (e.g., electronically formatted literary works). Many e-books, such as literary works which are primarily text-based (e.g., novels) can be paginated on-the-fly by the e-reading component 114, based on, for example, a display size of the device and/or font size settings of the user or device.

According to some embodiments, a multi-state slider feature 115 is provided with the e-reading component 114. The multi-state slider feature 115 can be implemented to have multiple states, each of which define a functionality for enabling a type of transition through paginated content of an e-book. The slider feature 115 receives linear input, and correlates a value of the linear input to a transition type and value, where the transition type can be determined from the state of the slider feature 115.

In some embodiments, the state of the slider feature 115 is selected initially by default, and then is changed based on the user providing a designated user input action. When in the default state, a linear change in value identified through manipulation of the slider feature 115 can correspond to, for example, a chapter transition type. The slider feature 115 can switch from the default state to an alternative state with the user specifying a designated user input action. For example, the user can signify a designated user input action that corresponds to a touch input on a display screen of the e-reading device where the slider feature 115 is displayed. In one implementation, the designated user input action can correspond to a touch and hold, which triggers the state associated with the slider feature to change. In one embodiment, the state associated with the slider feature 115 n change from the default designation to an alternative state. Still further, the alternative state of the slider feature 115 can enable the slider feature to be manipulated in order to specify a transition value that is of an in-chapter page transition type. When the slider feature is moved, a value determined from the movement is correlated to a page transition value, which is then implemented within a currently specified chapter of the e-book.

Hardware Description

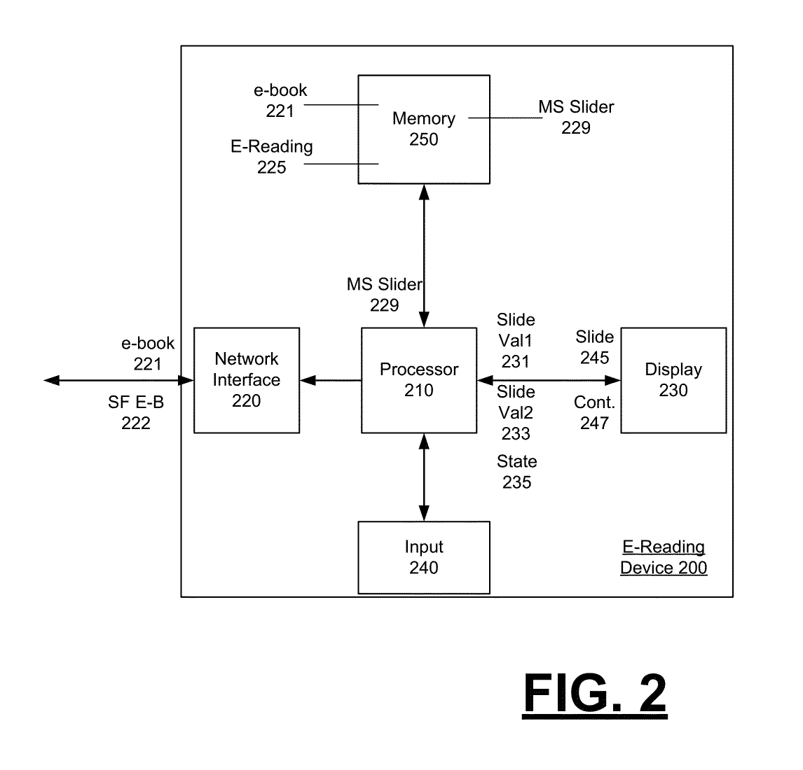

FIG. 2 illustrates an example of an e-reading device for use with one or more embodiments described herein. In an example of FIG. 2, an e-reading device 200 can correspond to, for example, a mobile computing device such as shown by an example of FIG. 1.

With reference to FIG. 2, e-reading device 200 includes a processor 210, a network interface 220, a display 230, one or more input mechanisms 240, and a memory 250. The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books, configuration files, account information), as well as to provide information (e.g., user account information, service requests etc.). For example, e-reading device 200 can receive application resources, such as media files (e.g., e-books 221) that the user elects to purchase or otherwise download from the network service 120. The application resources that are downloaded onto the e-reading device 200 can be stored in the memory 250.

In some implementations, the display 230 can correspond to, for example, a liquid crystal display (LCD) or light emitting diode (LED) display that illuminates in order to provide content generated from processor 210. In some variations, the display 230 can correspond to an electronic paper type display, which mimics conventional paper in the manner in which they display content. Examples of such display technologies include electrophoretic displays, electrowetting displays, and electrofluidic displays.

In some implementations, the display 230 can be touch-sensitive. For example, the display 230 can be integrated with a sensor layer that is comprised of capacitive touch sensors which trigger with contact to human skin. Alternatively, the display 230 can include alternative sensor layers, such as resistive sensors which can detect applied pressure from, for example, a human finger or stylus.

The processor 210 can receive input from various sources, including from input mechanisms 240 (e.g., buttons or switches, microphone, keyboard), the display 230 (e.g., soft buttons or virtual keyboard) or other input mechanisms (accessory devices). In one implementation, the processor 210 can process multi-touch input detected by the sensor layer provided on the display 230.

In one aspect, memory 250 stores instructions 225 (“e-reading instructions 225”) for operating an e-reading application (e.g., see e-reader component 114 in FIG. 1). The memory 250 can also store instructions for implementing a multistate slider (“MS slider 229”), such as described with an example of FIG. 1 (e.g., mufti-state slider 115″). The processor 210 can access the multistate slider instructions 229 in order to provide a slider feature 245 on display 230. The slider feature 245 can be provided in context of content 247, generated from, for example, e-book 221. For example, the content 247 can be generated by the e-reading component 114 (see FIG. 1) accessing a stored e-book 221. The slider feature 245 can be provided in, for example, a setting or option menu, so that it can be displayed concurrently with content 247. The display 230 can receive touch input which correlates to a position of the slider feature 245. In particular, the input can be based on a change in position of the slider feature 245, and this change can be correlated to a value. In one implementation, the input provided by the user in moving the slider feature 245 can be reflected as multiple (or a series) of slider values 231, 233. The slider values 231, 233 can reflect a new position (or a series of positions as the slider continuously moves) of the slider feature, a change in the position of the slider feature, a velocity of the slider feature, or other characteristic determined from position and time values as measured by the user's interaction with the slider feature 245 on the display 230.

The processor 210 can interpret the slider values 231, 233 as a value for a particular transition type. According to some embodiments, multiple types of transitions can be enabled through use of slider feature 245. In one implementation, slider feature 245 operates in a state in which the values of the slider feature (e.g., slider position on a linear scale) reflect a total page count of an e-book, and the slider values 231, 233 (as determined from a position of the slider) reflect a respective original (before transition initiated) and current page of the e-book.

As an addition or variation, the slider feature 245 can operate in a chapter transition state, where the slider values 231, 233 determine a chapter transition. In particular, a new slider value 233 can determine a new chapter designations as compared to a prior chapter designation reflected by slider value 231. As an addition or variation, the slider values 231, 233 can reflect a, magnitude and/or direction of a chapter transition, from a current chapter under view.

Still further, the slider 245 can operate in an in-chapter transition state, where the slider values 231, 233 determine the page transition within a chapter of a given e-book. More specifically, slider feature 245 operates in a state in which the values of the slider reflect a page count of a selected chapter, and the slider values 231, 233 (as determined from a position of the slider) reflect a respective original (before transition initiated) and current page of the e-book, but within the confines of the selected chapter.

According to some embodiments, the slider feature 245 can change states based on designated input actions provided by the user. For example, display 230 can detect a designated input action of the user, corresponding to the user providing a particular kind of touch input on the display screen where the slider feature 245 is displayed. When the designated input action is detected, a corresponding state input 235 is signaled. According to one implementation, the state input 235 can after the operational state of the slider feature 245 from the default state to an alternative state. Still further, in one implementation, the default state for the slider 245 can function to provide page transition across the total pages of the e-book 221. In a variation, the slider feature 245 can operate to provide chapter transitions when in the default state. The designated input action for altering the state of the slider feature 245 can correspond to, for example a touch and hold that extends a duration beyond a threshold. As an addition or variation, the designated input action can correspond to the user maintaining a single position when touching and holding the slider 245. Thus, for example, the user can manipulate the slider feature with movement of his or her finger across the display surface, but when the user wishes to change the state of the slider feature 245, the user can simply pause the finger on the display screen, and then interact with the slider feature in a different state of operation. The state change can be implemented as part of a continuous contact in which multiple transition input types are inputted through the state change of the slider feature.

The processor 210 can determine a transition value based on the slider values 231, 233. Additionally, the processor 210 can identify the state value 235 of the slider feature 245 based on the occurrence of a state change. The processor 210 can implement a page and/or chapter transition of an e-book 221 based on a transition value, as determined from the slider values 231, 233 and/or the state value 235.

Device System

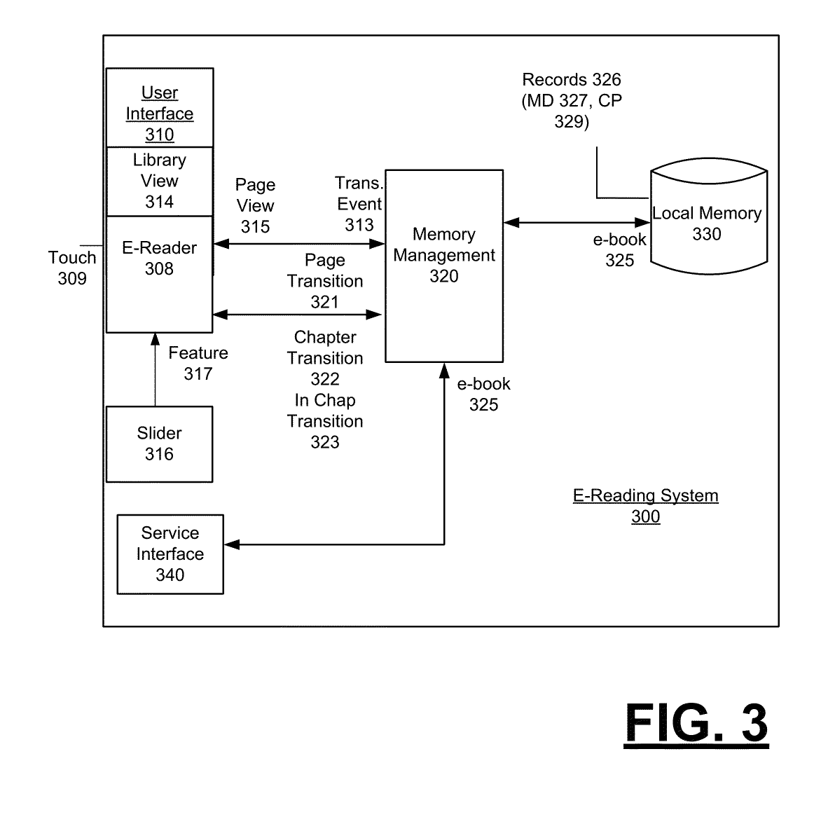

FIG. 3 illustrates an e-reading system in accordance with one or more embodiments. In reference to FIG. 3, a system 300 implements programmatic components for communicating with one or more network service (such as network service 120, shown in FIG. 1), as well as for enabling functionality for viewing and accessing content items (e.g., e-books) utilized by an account associated with the e-reading device 110 (see FIG. 1). In some embodiments, the system 300 can be implemented as an application that runs on an e-reading device, such as shown with examples of FIG. 1 or FIG. 2. In variations, the system 300 can be implemented as part of the operating system for the e-reading device.

In an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with the computing system 300 can be provided as part of an application that runs on, for example, the e-reading device 110 (see FIG. 1). For example, the user can download an application onto the device that is operated as the e-reading device 110, in order to obtain functionality such as described with an example of FIG. 3, as well as to communicate with the network service 120. Alternatively, an application can be embedded or otherwise preinstalled with other programmatic elements for providing functionality such as described with system 300.

The service interface 340 includes application logic which enables the e-reading device 110 to use, for example, a wireless Internet connection, to connect to the network service 120 (see FIG. 1). In connecting with the service, the service interface 340 can transmit data that enables the network service 120 to identify the e-reading device 110 on which system 300 is implemented, so that the network service 120 can determine the account that is associated with the particular e-reading device. The service interface 340 can be used to retrieve e-books 325 from the network service 120. For example, in identifying the e-reading device 110 of system 300 to the network service 120, the network service may be able to procure payment information (e.g., stored credit card information) that can be used to charge the user's account when the user purchases a new e-book from the service. Each e-book can correspond to a literary work having a pagination format, such as provided by literary works (e.g., novels), as well as pagination provided by periodicals (e.g., magazines, comic books, journals, etc.). Many e-books may have chapter designations, as well as content that corresponds to graphics or images (e.g., such as in the case of magazines or comic books). Individual e-books 325 also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reading device of system 300, the network service 120 can identify what e-books belong to the account associated with the particular device. The e-books that are transmitted to the e-reading device of system 300 can include, for example, those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reading device 110 to automatically receive their previously purchased e-book. As another example, network service 120 can be configured to push e-books to the e-reading device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reading device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

According to some embodiments, the local memory 330 stores each e-book as a record 326 that includes metadata 327 and content 329 (e.g., page content). The management module 320 can retrieve portions of the content 329 for individual e-books for purpose of rendering e-books via the user interface 310. Additionally, the management module 320 can retrieve metadata 327 to render metadata content (e.g., representations of e-books or lists of e-books) with the user interface 310.

In an example of FIG. 3, the user interface 310 of e-book system 300 includes an e-reading component 308, a library view component 314 and a slider component 316. The e-reading component 308 can include functionality to (i) render page views 315 from a particular e-book, and (ii) detect page transition events 313. The page views 315 can include the content portion 329 of the e-book being read (e.g., opened or rendered). For example, the e-reading component 308 can display a page view 315 from an e-book corresponding to a novel or periodical, and the page view may include text and/or image content. The page event 313 can correspond to, for example, a page turn, a chapter turn, or a clustered page turn. The page transition events 313 can be received as touch input 309 through the e-reading component 308. For example, a simple page turn can be signaled through touch input 300 that is a tap, provided in a direction that the user desires for the page transition.

The library view 314 can display objects and metadata that represent individual e-books and content items of the user library. In one implementation, the library view 314 can display metadata content based on the metadata portion 327 of individual e-books that are in the user library. The e-books that are in the user library can correspond to e-books stored with local memory 330, as well as archived e-books that are provided remotely (e.g., provided on network service 120).

More specifically, in some implementations, the memory management module 320 can be triggered into archiving e-books. In archiving an e-book, the content portion 329 of the e-book can be removed from the local memory 330, while the metadata portion 327 of the record 326 remains stored in the local memory 330. The trigger for archiving e-books can be based on the user input, or generated programmatically in response to events such as memory management processes (e.g., process to archive e-books that have been read; process to detect when free memory is below threshold, etc.). The library view component 314 can display the representation of the archived e-books using the metadata content 327.

The slider component 316 can be provided as functionality integrated with the e-reading component 308. For example, the slider component 316 can generate a slider feature 317 that is displayed through the e-reading component 308. The slider feature 317 can define a graphical region that is responsive to touch input 309 in order to invoke logic of the slider component 316 for purpose of processing the input. As described with other examples, when provided in connection with slider feature 317, some kinds of touch input 309 can be interpreted as (i) a slider value, indicating a magnitude and/or direction for transition; and (ii) a transition type, such as a chapter transition or an in-chapter page transition. Still further, another kind of touch input 309 can be interpreted as a state transition for the slider feature 317. When state transition input is detected, the transition type for the slider value can change, such as for example, from chapter transition type to an in-chapter page transition type. In this way, the slider feature 317 can be manipulated by the user through touch input 309 in order to signal transition values that are of a particular type, such as chapter transition or in-chapter page transition.

In more detail, the slider component 316 can detect manipulation of the slider feature 317 through touch input 309 when the slider feature is provided through the e-reading component 309. The slider component 316 can include logic for interpreting movement of the slider feature 317. In particular, the slider feature 317 can be interpreted for magnitude, position and/or direction. Additionally, the slider component 316 can interpret the movement of the slider feature 317 based on a state of the slider feature 317. For example, the states of the slider feature can include two or more of (i) a correlative representation of a total number of pages in an e-book, so that movement of the slider feature results in a transition that is based on a totality of pages in the e-book, without regard for chapter designation; (ii) a correlative representation of chapters in an e-book, so that movement of the slider feature results in transition by chapter designations of the e-book; and (iii) a correlative representation of pages of a select chapter in an e-book, so that movement of the slider feature results in transition by pages of the select chapter. Accordingly, based on the state of the slider feature 317, the slider component 316 can signal one of the page transition 321, chapter transition 322, and/or in-chapter transition 323, to the memory management module 320. Each of the page transition 321, chapter transition 322, and/or in-chapter transition 323 can be signaled as a corresponding value, which can include position, direction and/or magnitude. Based on the value, the memory management module 320 retrieves a page view 315 (or page views) from the local memory 326.

In some embodiments, the transition value for the particular transition type of the slider feature 317 is based on the location of the slider feature, such as before and after movement is initiated. In variations, the transition can be based directly on a magnitude determination, such as from a detected velocity in the movement of the slider feature 317.

Methodology

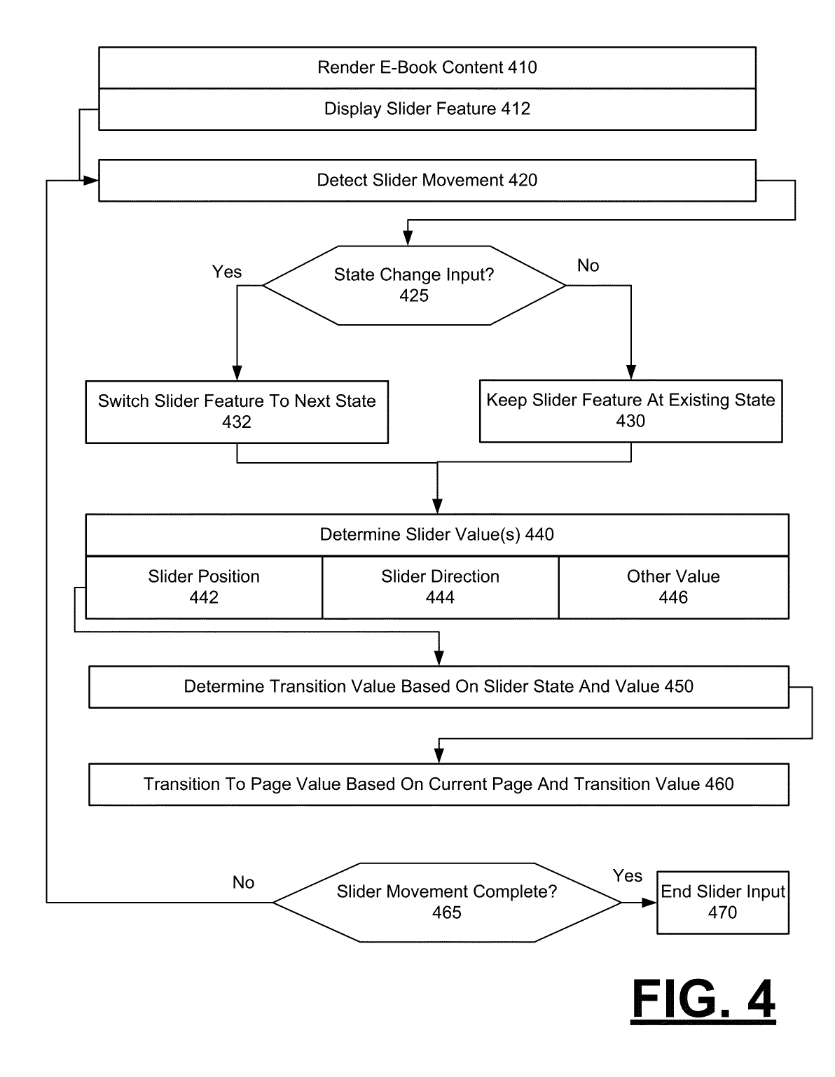

FIG. 4 illustrates a method for implementing a multistate slider feature for transitioning through an e-book, according to an embodiment. An example such as described by FIG. 4 can be implemented using components such as described with FIG. 1, FIG. 2, or FIG. 3. Accordingly, reference may be made to elements of other figures for purpose of illustrating suitable elements or components for performing a step or sub-step being described.

With reference to FIG. 4, and e-reading device renders content from an e-book (410). This can include paginated content, and conventional page transition mechanisms can be utilized to implement page transitions with or without use of the slider feature 317. For example, the user can tap an edge of a display screen of the device to perform a page turn. A slider feature can be concurrently displayed with the e-reading content (412). For example, the slider feature can be intermittently displayed as part of a menu function, provided on a perimeter of the e-reading space.

A movement of the slider feature can be detected (420). For example, the slider component 316 can receive input indicating a contact movement of the user, and then correlate the contact movement to one or more slider values. In this way, the movement of the slider feature can correspond to the user making contact with a touch sensitive display screen of the e-reading device 110, with the user touch coinciding in position to a movable element of a slider interface (e.g., circular element on a bar).

When input on the slider feature is detected, a determination can be made as to whether the input is to initiate a state change in the operation of the slider feature (425). The input for the state change can correspond to, for example, a sustained touch input that exceeds a designated threshold of time, and more specifically, to a sustained threshold during which the contact is maintained and the slider feature 317 remains static in position. By default, the slider feature 317 can reflect a particular state of operation, and a particular transition type corresponding to the state of operation. When a state change is detected, the input that can be interpreted from movement of the slider feature 317 is of a different transition type, coinciding with the current state of operation for the slider feature 317. If the determination is that the input is not a state change, then the slider feature 317 is maintained in an existing state of operation (430). If the determination is that the input is a state change, then the slider feature 317 is switched to a new state of operation (432). In one implementation, the new state of operation can be an alternative to the default state of operation. When there are multiple possible state of operations for the slider feature 317, the determination of which state is being selected by the input action can be based on, for example, a predetermined sequence of states for the slider feature 317.

Subsequently, one or more slider values are determined for the user interaction with the slider (440). In one implementation, multiple slider values are determined by sampling a position of the slider feature over duration of time. The duration of time coincides with when the slider feature 317 is first detected as being touched or otherwise initiated. The slider values that are determined can be based on one or more of (i) a relative position of the slider feature 317 along a slider scale (442), (ii) a direction of movement for the slider feature 317 along the slider scale (444), and/or (iii) other values associated with the movement of the slider feature, such as a magnitude or velocity of the slider feature (446).

A transition value can be determined based on the determined slider state and slider values (450). In the context of an e-book, the transition value reflects a page, or series of pages, which are rendered to the user from a previous page.

The transition value can be determined one or multiple times, upon movement of the slider feature being detected. When the transition value is detected, the e-reading device may transition the content of the e-book to a page that is selected based on the current page and the determined transition value (460). This can be done repetitively, for example, over the course of the duration in which the slider feature sampled for contact input.

When the transition value is determined, a determination can also be made as to whether the slider feature input is complete (465). In one implementation, the completion determination can be based on when the user ceases making contact with the display screen. Upon that moment, input for changing the state of the slider feature and/or specifying slider values cannot be made, unless the user re-contacts the slider feature to initiating new interaction. When completion of the slider feature input is detected, the end of the slider input is recorded (470), and no further page transitions may occur unless additional input is provided. If the determination is that the slider input is not complete, then the process can continue to detect the slider movement at (420).

By way of example, a slider feature 317 can be operated for a computing device as follows. A user can contact and move the slider feature 317 when viewing a page of an e-book. Initially by default, a state of the slider feature 317 is for chapter transitions, and the e-book is progressed by chapter based on movement of the slider feature. At a select chapter, the movement of the slider feature 317 can be paused while contact is maintained, in order to effect a state change for the slider feature. The movement can be reinitiated to reflect a page transition within a select chapter until a desired page in a select chapter is reached.

### Examples

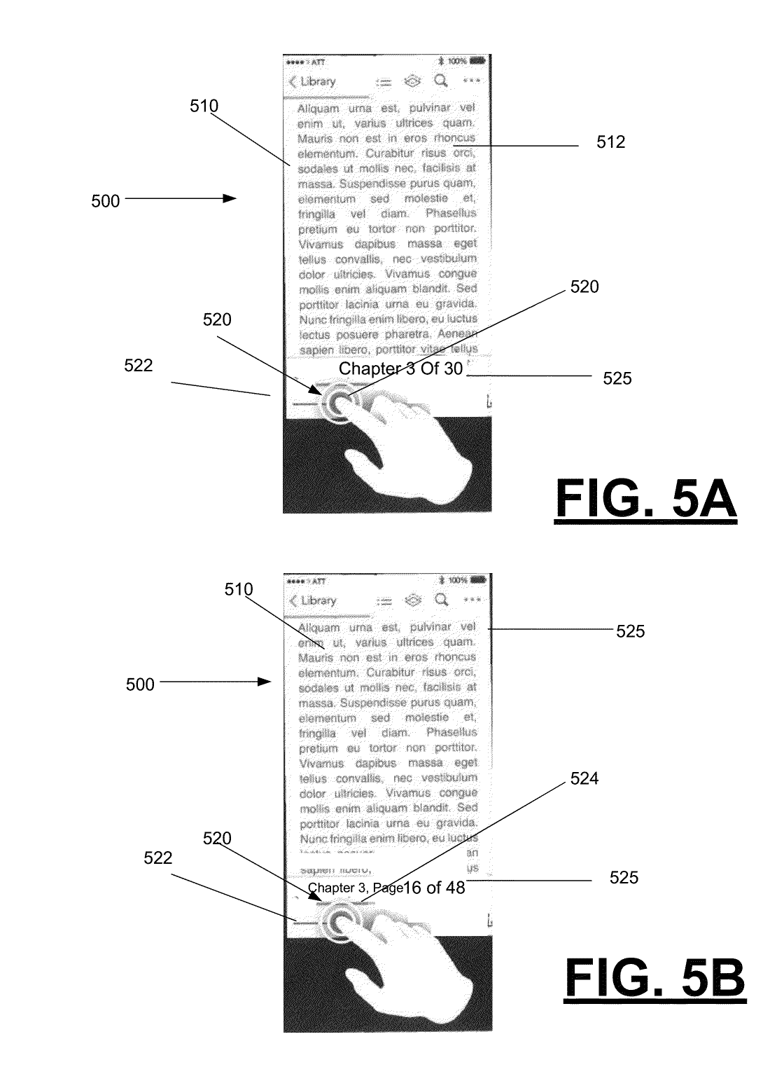

FIG. 5A and FIG. 5B illustrate an example of a multistate slider feature, according to one or more embodiments. In more detail, examples of FIG. 5A and FIG. 5B illustrate an e-reading device 500 including a display screen 510 on which e-book content 512 is provided. An interface provided with the e-book content 512 includes functionality such as provided with a slider feature 520.

In an example of FIG. 5A and FIG. 5B, slider feature 520 is defined by a linear scale 522 and a moveable element 524. Movement of the slider feature can thus correspond with the user making contact with the display screen at a location that coincides with the positioning of the element 524, and further by the user dragging the point of contact along the linear element 522 to in effect move the element 524.

In one example, the slider feature 520 can include a default state of operation in which transition values determined from movement of the element 524 correlate to chapter progressions. Feedback 525 can be provided to the user to identify a current chapter that can be viewed, based on the current position of the element 524. The feedback 525 can also identify, for example, a total number of chapter designations within a particular e-book, so that movement of the element 524 reflects progression by chapters from the totality of chapters.

In one implementation, the slider feature 520 has a default state of operation corresponding to chapter progressions. A user input can be detected to change the state of operation for the slider feature 520. The user can provide input that is distinct from movement of the slider feature in order to specify input that does not reflect a transition value. By way of example, the input action for changing a state of operation of the slider feature can correspond to a pause, for example, when a user performs a touch and hold. In one example, an alternative state of operation for the slider feature can correspond to an in-chapter page transition. For example, a current chapter of the e-book can be represented linearly to reflect the pages that comprise the chapter. When the slider feature operates in the in-chapter page transition, the element 524 of the slider feature 520 can be along the linear element 522 to affect page transition within a selected chapter.

According to another example, a single continuous touch contact with slider feature 520 can implement multiple types of transition input. More specifically, a user can initiate movement of the slider feature 520 to implement a transition of a type as specified by, for example, default (e.g., transition by chapters). Without ceasing contact with the display screen, a user can pause the linear input in order to change a state of operation for the slider feature. At the new state, further input of the slider feature can be interpreted differently depending on the state of the slider feature 520.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a memory resource to store a set of instructions and an e-book, the e-book including a plurality of predetermined chapter designations;
one or more processors that access the memory resource to:
render at least a portion of an e-book, including displaying individual pages of the e-book;
while displaying one or more pages of the e-book, implement a slider feature to have multiple possible states, the slider feature including a graphical element that can be moved linearly to indicate a value;
wherein the slider feature can be implemented in multiple states, including at least (i) a first state, in which the slider feature can be moved linearly to signal transition through the e-book by chapter designation, and (ii) a second state, in which the slider feature can be moved linearly to signal transition through a current chapter by pages;
select to operate the slider feature in at least one of the first state or second state based on one or more designated user actions;
when the slider feature is implemented in the first state, respond to input for moving the slider by transitioning through chapter designations of the e-book in a manner that coincides with movement of the slider feature in the first state; and
when the slider feature is implemented in the second state, respond to input for moving the slider by transitioning through pages of a current chapter designation to in a manner that coincides with movement of the slider feature in the second state.

2. The computing device of claim 1, wherein the one or more processors recognize a first designated input action for selecting at least one of the first state or second state as a touch input provided on the slider feature.

3. The computing device of claim 1, wherein the one or more processors implement the slider feature in one of the first state or second state by default, and transition from the default to the other of the first state or second state in response to receiving a first designated user input action.

4. The computing device of claim 1, wherein the one or more processors select to operate the slider in one of the first state or second state in response to a first designated user input action corresponding to a user sustaining a touch contact on the slider feature without movement for a duration of time that exceeds a threshold.

5. The computing device of claim 4, wherein the one or more processors detect the first designated user input action as part of a sustained continuous action that includes (i) at least a first slider movement to a first position when the slider feature is in the in one of the first state or second state, (ii) the first designated user input action to switch the slider feature from the first state or second state to the other of the first state or second state, and (iii) at least a second slider movement to a second position when the slider feature is in the other of the first state or second state.

6. The computing device of claim 5, wherein the one or more processors (i) determine a corresponding value of the first position, and implement one of a chapter transition or an in-chapter page transition based at least in part on the corresponding value of the first position; and (ii) determine a corresponding value of the second position, and implement the other of the chapter transition or in-chapter page transition based at least in part on the second value.

7. The computing device of claim 5, wherein the slider feature implements chapter transitions when in the first state and in-chapter page transitions when in the second state, and wherein after the one or more processors detect the first designated user input action, the one or more processors display an in-chapter page number that is based on the first value of the slider feature until the second slider movement is detected.

8. The computing device of claim 1, wherein the one or more processors operate to:
detect a first slider movement;
implement a chapter transition while rendering the e-book based on one or more values of the detected first slider movement;
detect a first designated user action;
detect a second slider movement after the first designated user action;
implement an in-chapter page transition while rendering the e-book based on or more values of the second slider movement.

9. The computing device of claim 8, wherein the one or more processors implement each of the chapter transition and the in-chapter page transition by displaying one or more current chapters or one or more current page numbers in response to the respective first or second slider movements.

10. The computing device of claim 8, wherein the one or more processors detect the one or more values for the first slider movement to reflect one or more of (i) at least a new position of the slider feature, (ii) a direction of movement, or (iii) a velocity of the slider feature when moved to the new position.

11. The computing device of claim 8, wherein the one or more processors detect the one or more values for the second slider movement to reflect one or more of (i) at least a new position of the slider feature, (ii) a direction of movement, or (iii) a velocity of the slider feature when moved to the new position.

12. The computing device of claim 1, wherein the slider feature can be implemented in a third state in which the slider feature can be moved linearly to reflect a value for total page count.

13. The computing device of claim 12, wherein the one or more processors select to operate the slider feature in at least the third state based on a second designated user input action.

14. A method for operating a computing device, the method being implemented by one or more processors and comprising:
rendering at least a portion of an e-book, including displaying individual pages of the e-book;
while displaying one or more pages of the e-book, implementing a slider feature to have multiple possible states, the slider feature including a graphical element that can be moved linearly to indicate a value;
selecting to operate the slider feature in at least one of a first state or a second state based on one or more designated user actions;
when the slider feature is implemented in the first state, responding to input for moving the slider by transitioning through chapter designations of the e-book based on a movement of the slider feature in the first state; and
when the slider feature is implemented in the second state, responding to input for moving the slider by transitioning through pages of a current chapter designation of the e-book based on movement of the slider feature in the second state.

15. The method of claim 14, wherein selecting to operate the slider feature includes detecting a first designated input action provided by touch input for selecting at least one of the first state or second state of the slider feature.

16. The method of claim 14, further comprising implementing the slider feature in one of the first state or second state by default, and transitioning from the default to the other of the first state or second state in response to receiving a first designated user input action.

17. The method of claim 14, further comprising selecting to operate the slider in one of the first state or second state in response to a first designated user input action corresponding to a user sustaining a touch contact on the slider feature without movement for a duration of time that exceeds a threshold.

18. The method of claim 17, further comprising detecting the first designated user input action as part of a sustained continuous action that includes (i) at least a first slider movement to a first position when the slider feature is in the in one of the first state or second state, (ii) the first designated user input action to switch the slider feature from the first state or second state to the other of the first state or second state, and (iii) at least a second slider movement to a second position when the slider feature is in the other of the first state or second state.

19. The method of claim 18, further comprising (i) determining a corresponding value of the first position, and implementing one of a chapter transition or an in-chapter page transition based at least in part on the corresponding value of the first position; and (ii) determining a corresponding value of the second position, and implementing the other of the chapter transition or in-chapter page transition based at least in part on the second value.

20. A method for operating a computing device, the method being implemented by one or more processors and comprising:
providing a slider feature while rendering an e-book;
detecting a first slider movement;
implementing a chapter transition while rendering the e-book based on one or more values detected from the first slider movement;
detecting a first designated user action;
detecting a second slider movement after the first designated user action; and
implementing an in-chapter page transition while rendering the e-book based on or more values of the second slider movement.
